(19) United States
(12) Patent Application Publication
(10) Pub. No.: US 2021/0117619 A1
(43) Pub. Date: Apr. 22, 2021

(54) CYBERBULLYING DETECTION METHOD AND SYSTEM

(71) Applicant: Nanjing University of Aeronautics and Astronautics, Nanjing (CN)

(72) Inventors: Bohan Li, Nanjing (CN); Anman Zhang, Nanjing (CN); Shuo Wan, Nanjing (CN); Wenhuan Wang, Nanjing (CN); Xueliang Wang, Nanjing (CN); Xue Li, Nanjing (CN)

(21) Appl. No.: 17/072,292

(22) Filed: Oct. 16, 2020

(30) Foreign Application Priority Data
Oct. 18, 2019 (CN) 201910992761.2

(51) Int. Cl. G06F 40/279; G06N 3/04; G06N 3/08; G06N 7/00; G06K 9/62; G06F 40/35

(52) U.S. Cl. CPC G06F 40/279; G06N 3/04; G06N 3/08; G06F 40/35; G06K 9/6256; G06K 9/6298; G06N 7/005

(57) ABSTRACT

The disclosure discloses a cyberbullying detection method and system. The detection method includes: obtaining a to-be-detected data set, where the to-be-detected data set includes multiple sentence texts of multiple users; classifying the to-be-detected data set by using a classification model based on a bidirectional recurrent neural network, to obtain a probability that each sentence text belongs to cyberbullying; obtaining a sentence text whose probability of belonging to cyberbullying is greater than a specified probability, to obtain a first sentence text set; obtaining an attention value of each sentence text in the first sentence text set and an attention value of each user; detecting, according to the attention value of each sentence text in the first sentence text set and the attention value of each user, whether each sentence text belongs to cyberbullying. The disclosure can achieve a good text classification and identification effect, high accuracy, and a low loss rate.

### TECHNICAL FIELD

The disclosure relates to the network information detection field, and in particular, to a cyberbullying detection method and system.

### BACKGROUND

Social networking brings much convenience to people's lives, but it also brings a series of serious problems including cyberbullying. Cyberbullying is a type of radical and intentional behavior in which a group or an individual attacks a victim on the Internet. Existing cyberbullying detection mostly focuses on classifying texts or images with short captions by using insulting words. For example, an SVM method, a Logistic regression method, etc. are adopted. Such detection methods have certain advantages in the detection accuracy, but they cannot realize capture of semantic information implied by non-insulting words.

Cyberbullying not only involves insulting words, but also involves attacks of non-insulting words. However, information about these non-insulting words cannot be detected by using an existing detection method. Consequently, a result of detecting cyberbullying behavior by using the existing method is not accurate.

### SUMMARY

The disclosure aims to provide a cyberbullying detection method and system, to improve the accuracy of a cyberbullying detection result.

To achieve the above objective, the disclosure provides the following solutions: A cyberbullying detection method, including:

obtaining a to-be-detected data set, where the to-be-detected data set includes multiple sentence texts of multiple users;

classifying the to-be-detected data set by using a classification model based on a bidirectional recurrent neural network, to obtain a probability that each sentence text belongs to cyberbullying;

obtaining a sentence text whose probability of belonging to cyberbullying is greater than a specified probability, to obtain a first sentence text set;

obtaining an attention value of each sentence text in the first sentence text set and an attention value of each user; and

detecting, according to the attention value of each sentence text in the first sentence text set and the attention value of each user, whether each sentence text belongs to cyberbullying.

Optionally, before the classifying the to-be-detected data set by using a classification model based on a bidirectional recurrent neural network, to obtain a probability that each sentence text belongs to cyberbullying, the method further includes:

cleaning each sentence text in the to-be-detected data set to remove a non-alphabetic character, to obtain a preprocessed text sequence.

Optionally, the classifying the to-be-detected data set by using a classification model based on a bidirectional recurrent neural network, to obtain a probability that each sentence text belongs to cyberbullying specifically includes:

inputting the to-be-detected data set into an embedding layer of the classification model, conducting word segmentation processing on each sentence text, and converting each word into a word vector to obtain a vector matrix corresponding to each sentence text;

inputting the vector matrix corresponding to each sentence text into a bidirectional recurrent neural network layer of the classification model, to obtain an output vector, at a hidden layer of the bidirectional recurrent neural network layer, of each word vector corresponding to the sentence text;

inputting the output vector of each word vector at the hidden layer of the bidirectional recurrent neural network layer into an attention layer of the classification model, to obtain an attention value of each word; and conducting normalization processing according to the attention value of each word, to obtain the probability that each sentence text belongs to cyberbullying.

Optionally, the inputting the output vector of each word vector at the hidden layer of the bidirectional recurrent neural network layer into an attention layer of the classification model, to obtain an attention value of each word specifically includes:

calculating the attention value of each word by using a formula

$${a}_{in} = \frac{{e}^{{u}_{in}^{T} {u}_{w}}}{{Σ}_{n} {e}^{{u}_{ik}^{T} {u}_{w}}} ,$$

where u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

Optionally, the obtaining an attention value of each sentence text in the first sentence text set and an attention value of each user specifically includes:

averaging attention values of all words in the sentence text to obtain the attention value of the sentence text, where an attention value of each word is obtained in the process of classifying the to-be-detected data set by using the classification model based on the bidirectional recurrent neural network; and

averaging attention values of all sentence texts corresponding to the user to obtain the attention value of the user.

Optionally, after the detecting, according to the attention value of each sentence text in the first sentence text set and the attention value of each user, whether each sentence text belongs to cyberbullying, the method further includes:

obtaining all sentence texts that belong to cyberbullying, to obtain a second sentence text set; and

determining a bullying degree of each sentence text in the second sentence text set by using a formula

$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$

where severity is a value of the bullying degree of the sentence text, bₐₜₜ represents an attention value of the sentence text, p_{b} represents the number of all sentence texts written by a user corresponding to the sentence text, asst_{t,att} represents an attention value of a sentence text of an i^{th} assistant of the user, and pₐₛₛₜ_{ᵢ} represents the number of all sentence texts written by the i^{th} assistant of the user.

The disclosure further provides a cyberbullying detection system, including:

a to-be-detected data set obtaining module, configured to obtain a to-be-detected data set, where the to-be-detected data set includes multiple sentence texts of multiple users;

a classification module, configured to classify the to-be-detected data set by using a classification model based on a bidirectional recurrent neural network, to obtain a probability that each sentence text belongs to cyberbullying

a first-sentence-text-set obtaining module, configured to obtain a sentence text whose probability of belonging to cyberbullying is greater than a specified probability, to obtain a first sentence text set;

an attention value obtaining module, configured to obtain an attention value of each sentence text in the first sentence text set and an attention value of each user; and

a cyberbullying detection module, configured to detect, according to the attention value of each sentence text in the first sentence text set and the attention value of each user, whether each sentence text belongs to cyberbullying.

Optionally, the classification module specifically includes:

an embedding layer processing unit, configured to input the to-be-detected data set into an embedding layer of the classification model, conduct word segmentation processing on each sentence text, and convert each word into a word vector to obtain a vector matrix corresponding to each sentence text;

a bidirectional recurrent neural network layer processing unit, configured to input the vector matrix corresponding to each sentence text into a bidirectional recurrent neural network layer of the classification model, to obtain an output vector, at a hidden layer of the bidirectional recurrent neural network layer, of each word vector corresponding to the sentence text;

an attention layer processing unit, configured to input the output vector of each word vector at the hidden layer of the bidirectional recurrent neural network layer into an attention layer of the classification model, to obtain an attention value of each word; and

a normalization processing unit, configured to conduct normalization processing according to the attention value of each word, to obtain the probability that each sentence text belongs to cyberbullying.

Optionally, the attention layer processing unit calculates the attention value of each word by using a formula

$${a}_{in} = \frac{{e}^{{u}_{in}^{T} {u}_{w}}}{{Σ}_{n} {e}^{{u}_{ik}^{T} {u}_{w}}} ,$$

where u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

Optionally, the system further includes:

a second-sentence-text-set obtaining module, configured to: after it is detected, according to the attention value of each sentence text in the first sentence text set and the attention value of each user, whether each sentence text belongs to cyberbullying, obtain all sentence texts that belong to cyberbullying, to obtain a second sentence text set; and

a bullying degree determining module, configured to determine a bullying degree of each sentence text in the second sentence text set by using a formula

$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$

where severity is a value of the bullying degree of the sentence text, bₐₜₜ represents an attention value of the sentence text, p_{b} represents the number of all sentence texts written by a user corresponding to the sentence text, asst_{i,att} represents an attention value of a sentence text of an i^{th} assistant of the user, and pₐₛₛₜ_{ᵢ} represents the number of all sentence texts written by the i^{th} assistant of the user.

According to specific examples provided in the disclosure, the disclosure discloses the following technical effects:

In the disclosure, an attention model including a bidirectional recurrent neural network layer and an attention layer is adopted to identify a main bully in cyberbullying. The attention model vividly shows the influence of each English word in a sentence on the final type judgment, and can accurately identify whether non-insulting words or other words belong to cyberbullying. Moreover, the attention model can achieve high accuracy and a low loss rate in cyberbullying detection.

In addition, a degree of cyberbullying can further be measured by using a weight of the attention layer. In a subsequent cyberbullying control process, a management and control policy can be developed according to the degree of cyberbullying, providing a decision-making basis for the cyberbullying control and treatment.

### BRIEF DESCRIPTION OF DRAWINGS

To describe the technical solutions in the examples of the disclosure or in the prior art more clearly, the following briefly describes the accompanying drawings required for the examples. Apparently, the accompanying drawings in the following description show merely some examples of the disclosure, and a person of ordinary skill in the art may still derive other accompanying drawings from these accompanying drawings without creative efforts.

FIG. 1 is a schematic flowchart of a cyberbullying detection method according to the disclosure;

FIG. 2 is a schematic structural diagram of a cyberbullying detection system according to the disclosure;

FIG. 3 is a schematic flowchart of a specific example according to the disclosure;

FIG. 4 is a schematic diagram of a text classification process in a specific example according to the disclosure; and

FIG. 5 is a schematic distribution diagram of attention values of all words on a topic in a specific example according to the disclosure.

### DETAILED DESCRIPTION

The following clearly and completely describes the technical solutions in the examples of the disclosure with reference to accompanying drawings in the examples of the disclosure. Apparently, the described examples are merely a part rather than all of the examples of the disclosure. All other examples obtained by persons of ordinary skill in the art based on the examples in the disclosure without creative efforts shall fall within the protection scope of the disclosure.

To make the above objectives, features, and advantages of the disclosure more obvious and understandable, the disclosure is further described in detail below with reference to the accompanying drawings and detailed examples.

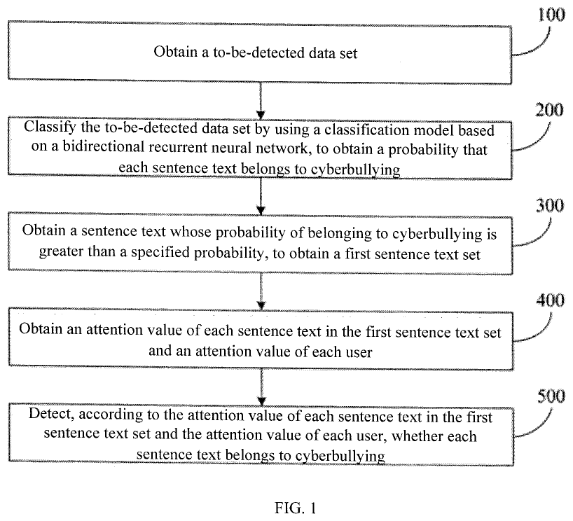

FIG. 1 is a schematic flowchart of a cyberbullying detection method according to the disclosure. As shown in FIG. 1, the cyberbullying detection method includes the following steps.

Step 100. Obtain a to-be-detected data set. The to-be-detected data set includes multiple sentence texts of multiple users. The disclosure is mainly based on detection of cyberbullying that occurs on social networking sites. Therefore, the to-be-detected data set is usually from social networking sites. For example, a data set may be obtained from a social networking site MySpace, and includes multiple English posts on multiple topics. Each post corresponds to one user, and each post may include multiple sentence texts or one sentence text.

Step 200. Classify the to-be-detected data set by using a classification model based on a bidirectional recurrent neural network, to obtain a probability that each sentence text belongs to cyberbullying.

Before the to-be-detected data set is classified, the classification model based on the bidirectional recurrent neural network needs to be constructed. The classification model based on the bidirectional recurrent neural network in the disclosure includes four layers: an embedding layer, a bidirectional recurrent neural network layer, an attention layer, and a fully connected layer. After the classification model is constructed, two thirds of sample data is selected to train the constructed classification model; and then the remaining one third of the sample data is selected to test the effectiveness and accuracy of the constructed classification model. According to an actual requirement, a part of a detection result can be displayed. For example, words in a text that have relatively large influence on the final type judgment are displayed, and these words are stored as a lexicon to better train the classification model.

Before the to-be-detected data set is classified, the to-be-detected data set may be preprocessed first. For example, each sentence text in the to-be-detected data set is cleaned to remove a non-alphabetic character, to obtain a preprocessed text sequence. Then, the trained classification model is used to classify the preprocessed text sequence. This can further improve the classification accuracy. If the text data is not preprocessed, the trained classification model can be directly used to classify the to-be-detected data set. A specific classification process is as follows:

(1) Input the to-be-detected data set into an embedding layer of the classification model, conduct word segmentation processing on each sentence text, and convert each word into a word vector to obtain a vector matrix corresponding to each sentence text. For example, word segmentation is conducted on a sentence text Sᵢ, and each word is converted into a word vector to obtain all word vector sequences wᵢ₁, wᵢ₂, . . . , wᵢₙ, to obtain a vector matrix W=(wᵢ₁, wᵢ₂, . . . , wᵢₙ) corresponding to the sentence text Sᵢ.

(2) Input the vector matrix corresponding to each sentence text into a bidirectional recurrent neural network layer of the classification model, to obtain a state vector hᵢₙ, at a hidden layer of the bidirectional recurrent neural network layer, of each word vector corresponding to the sentence text; and obtain an output vector uᵢₙ of each word vector at the hidden layer of the bidirectional recurrent neural network layer by using a formula uᵢₙ=tan h(W_{w} hᵢₙ+b_{w}). tan h(•) represents a hyperbolic tangent function, W_{w} is a weight of an attention layer, b_{w} is a deviation of the attention layer, hᵢₙ is a state vector of a word vector wᵢₙ at the hidden layer of the bidirectional recurrent neural network layer, uᵢₙ is a vector represented by an output obtained after the state vector hᵢₙ passes through a forward layer and a backward layer. An input of the bidirectional recurrent neural network layer is a word vector, and sent to both the forward layer and the backward layer of the bidirectional recurrent neural network. The two layers are connected to a same output layer. Each neuron at the output layer includes historical context information and future context information of an input sequence, and the future context information is expressed with updated hᵢₙ (by comprehensively considering neurons at a forward hidden layer and a backward hidden layer). From a horizontal perspective, hᵢₙ at each moment is determined by an output of hᵢₙ at a previous moment and a current word vector.

(3) Input the output vector of each word vector at the hidden layer of the bidirectional recurrent neural network layer into an attention layer of the classification model, to obtain an attention value of each word. Specifically, the attention value of each word is calculated by using a formula

$${a}_{in} = \frac{{e}^{{u}_{in}^{T} {u}_{w}}}{{Σ}_{n} {e}^{{u}_{ik}^{T} {u}_{w}}} ,$$

where u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

(4) Conduct normalization processing according to the attention value of each word, to obtain the probability that each sentence text belongs to cyberbullying. An attention value function is a normalized exponential function (softmax function), and a score is mapped to an interval (0, 1) to obtain the probability of each attention value. The probability that the sentence text belongs to cyberbullying is obtained by using a function [symbol] ×aᵢ₁ [symbol] ×aᵢ₂ [symbol] ×aᵢₙ=C, where C is an classification probability obtained by normalizing a vector that incorporates context information, that is, the probability that each sentence text belongs to cyberbullying.

Step 300. Obtain a sentence text whose probability of belonging to cyberbullying is greater than a specified probability, to obtain a first sentence text set. The sentence text whose probability is greater than the specified probability is more likely to belong to cyberbullying. Therefore, it is necessary to further determine whether this part of sentence text belongs to cyberbullying.

Step 400. Obtain an attention value of each sentence text in the first sentence text set and an attention value of each user. Specifically, the attention value of the sentence text is obtained by averaging attention values of all words in the sentence text; and the attention value of the user is obtained by averaging attention values of all sentence texts corresponding to the user. An attention value of each word may be obtained in the process of classifying the to-be-detected data set by using the classification model based on the bidirectional recurrent neural network.

Step 500. Detect, according to the attention value of each sentence text in the first sentence text set and the attention value of each user, whether each sentence text belongs to cyberbullying. For example, if an attention value of a sentence text of a user is higher than a specified threshold, it can be determined that cyberbullying occurs. The specified threshold can be specified according to an actual requirement. For example, the specified threshold may be specified according to the attention value of each sentence text in the first sentence text set and the attention value of each user, or may be specified according to a sensitivity degree of the to-be-detected data set or other factors.

In another embodiment, after it is learned whether each sentence text belongs to cyberbullying, a bullying degree of a sentence text that belongs to cyberbullying may further be detected, so as to facilitate providing a decision-making basis for subsequent management of network security or a social platform. During detection of a bullying degree, all sentence texts that belong to cyberbullying are first obtained to obtain a second sentence text set; and then a bullying degree of each sentence text in the second sentence text set is determined by using a formula

$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$

where severity is a value of the bullying degree of the sentence text, bₐₜₜ represents an attention value of the sentence text, p_{b} represents the number of all sentence texts written by a user corresponding to the sentence text, asst_{i,att} represents an attention value of a sentence text of an i^{th} assistant of the user, and pₐₛₛₜ_{ᵢ} represents the number of all sentence texts written by the i^{th} assistant of the user.

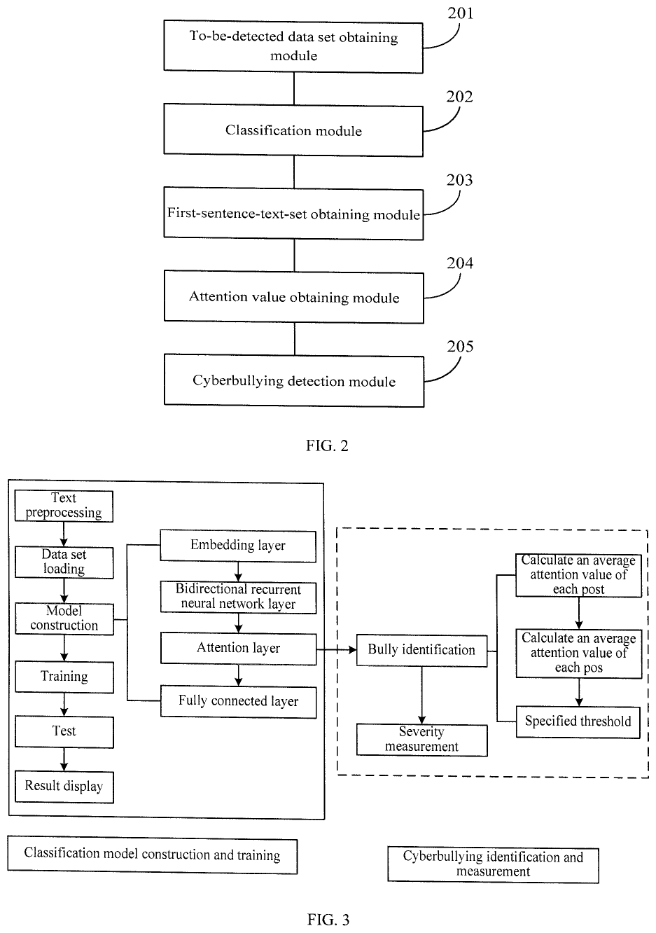

Corresponding to the cyberbullying detection method shown in FIG. 1, FIG. 2 is a schematic structural diagram of a cyberbullying detection system according to the disclosure. As shown in FIG. 2, the cyberbullying detection system includes the following structures:

a to-be-detected data set obtaining module 201, configured to obtain a to-be-detected data set, where the to-be-detected data set includes multiple sentence texts of multiple users;

a classification module 202, configured to classify the to-be-detected data set by using a classification model based on a bidirectional recurrent neural network, to obtain a probability that each sentence text belongs to cyberbullying;

a first-sentence-text-set obtaining module 203, configured to obtain a sentence text whose probability of belonging to cyberbullying is greater than a specified probability, to obtain a first sentence text set;

an attention value obtaining module 204, configured to obtain an attention value of each sentence text in the first sentence text set and an attention value of each user; and

a cyberbullying detection module 205, configured to detect, according to the attention value of each sentence text in the first sentence text set and the attention value of each user, whether each sentence text belongs to cyberbullying.

In another example, the classification module 202 in the cyberbullying detection system specifically includes:

an embedding layer processing unit, configured to input the to-be-detected data set into an embedding layer of the classification model, conduct word segmentation processing on each sentence text, and convert each word into a word vector to obtain a vector matrix corresponding to each sentence text;

a bidirectional recurrent neural network layer processing unit, configured to input the vector matrix corresponding to each sentence text into a bidirectional recurrent neural network layer of the classification model, to obtain an output vector, at a hidden layer of the bidirectional recurrent neural network layer, of each word vector corresponding to the sentence text;

an attention layer processing unit, configured to input the output vector of each word vector at the hidden layer of the bidirectional recurrent neural network layer into an attention layer of the classification model, to obtain an attention value of each word; and

a normalization processing unit, configured to conduct normalization processing according to the attention value of each word, to obtain the probability that each sentence text belongs to cyberbullying.

In another example, the attention layer processing unit in the cyberbullying detection system calculates the attention value of each word by using a formula

$${a}_{in} = \frac{{e}^{{u}_{in}^{T} {u}_{w}}}{{Σ}_{n} {e}^{{u}_{ik}^{T} {u}_{w}}} ,$$

where u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

In another example, the cyberbullying detection system further includes:

a second-sentence-text-set obtaining module, configured to: after it is detected, according to the attention value of each sentence text in the first sentence text set and the attention value of each user, whether each sentence text belongs to cyberbullying, obtain all sentence texts that belong to cyberbullying, to obtain a second sentence text set; and

a bullying degree determining module, configured to determine a bullying degree of each sentence text in the second sentence text set by using a formula

$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$

where severity is a value of the bullying degree of the sentence text, bₐₜₜ represents an attention value of the sentence text, p_{b} represents the number of all sentence texts written by a user corresponding to the sentence text, asst_{i,att} represents an attention value of a sentence text of an i^{th} assistant of the user, and pₐₛₛₜ_{ᵢ} represents the number of all sentence texts written by the i^{th} assistant of the user.

The following provides a specific example to further describe the solution of the disclosure.

This specific example is implemented on a machine with an Intel core i7 CPU and a 16-GB RAM. In an attention detection algorithm based on a bidirectional recurrent neural network, the Python language is used for coding, to discover potential cyberbullying according to text information. A final result is an average value of values obtained after an experiment is repeated for 5 times.

In this specific example, cyberbullying detection is conducted on three data sets from a social network in a manner shown in FIG. 3. FIG. 3 is a schematic flowchart of the specific example in the disclosure. The three data sets are from Formspring, Twitter, and MySpace. Formspring is a question and answer platform launched in 2009. Twitter provides a microblogging service that allows users to update a message within 140 characters. MySpace is a social networking site, providing global users with an interactive platform integrating social networking, personal information sharing, instant messaging, and other functions.

Formspring: This data set contains 40,952 posts from 50 ids in Formspring. Each post is crowdsourced to three workers of Amazon Mechanical Turk (AMT) for labeling bullying content with “yes” or “no”. Approximately 3,469 posts are regarded as a bullying type by at least one worker and 37,349 posts are regarded as a non-cyberbullying type. The rest of the data is not given a definitive judgment.

Twitter: This data set is collected from the Twitter stream API. There are 7321 tweets including 2102 tweets labeled with “yes” and 5219 tweets labeled with “no”. All the data has been labeled by experienced cyberbullying researchers.

MySpace: A selected data set contains 381,557 posts that belong to 16,345 topics. First, swear words and curse words from a website called Swear Word List & Curse Filter are saved. Other Internet slang and British slang containing slang and acronyms that include foul words are also saved. Then these words are matched with content of all posts to automatically label each post. If a post contains bullying content, it is labeled as 1, or otherwise, it is labeled as 0. In all topics, there are 10,629 labels 1 and 5716 labels 0. In addition to automatically labeled data set, a fact data set is further introduced to test the label reliability. The fact data set includes 3,104 pieces of text data, and is divided into 11 packages. Three independent experts manually label data that contains bullying content. If a file contains bullying content, it is labeled as 1, or otherwise, it is labeled as 0. A file labeled as “cyberbullying” needs to be labeled as 1 by at least two experts.

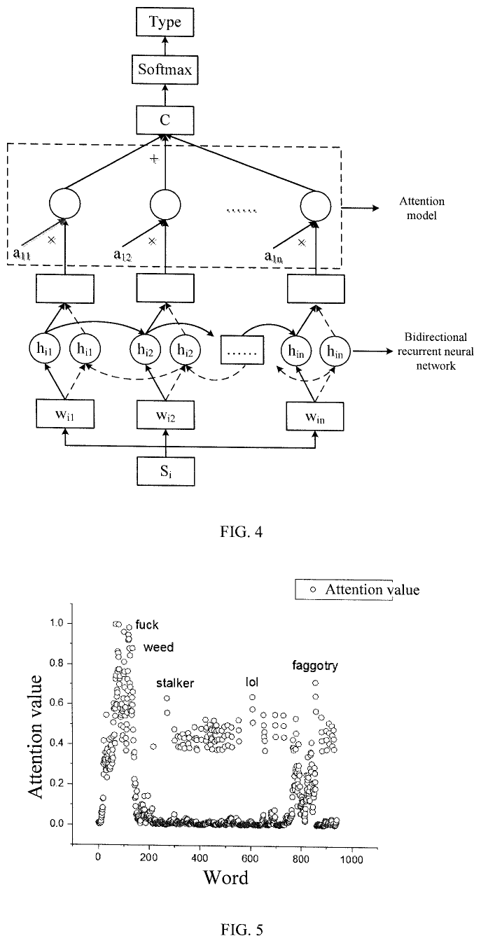

Then, the three data sets are classified by using a classification process shown in FIG. 4. FIG. 4 is a schematic diagram of the text classification process in the specific example according to the disclosure. For a neural network, a discard rate and a learning rate are two main factors that affect a training effect. The discard rate is set to avoid overfitting by discarding some neurons at a hidden layer. The learning rate is a speed of a process of reaching an optimal parameter value. Better performance of a gradient descent method can be achieved by selecting an appropriate learning rate. The learning rate is kept unchanged and the discard rate is adjusted, so that retention rates of neurons are 60%, 70%, and 80%. The discard rate is kept unchanged and the learning rate is adjusted, so that learning rates are 1e-3, 1e-4, and 1e-5.

An average attention value of each post and an average attention value of each user are calculated. As shown in FIG. 5, FIG. 5 is a schematic distribution diagram of attention values of all words on a topic in a specific example according to the disclosure. Then a threshold is determined. If an average attention value of content of a post of a user is higher than a specified threshold, it can be determined that cyberbullying occurs.

Finally, a main bully and other assistants related to a topic are comprehensively considered, and a potential adverse effect of a topic on a victim is measured according to a severity calculation formula by using an attention value.

Each example of the present specification is described in a progressive manner, and each example focuses on the difference from other examples. For the same and similar parts between the examples, mutual reference may be made. For the system disclosed in the examples, since the system corresponds to the method disclosed in the examples, the description is relatively simple. For a related description thereof, reference may be made to the description about the method.

Several examples are used herein for illustration of the principle and implementations of the disclosure. The description of the foregoing examples is used to help illustrate the method in the disclosure and the core principle thereof. In addition, a person of ordinary skill in the art can make various modifications in terms of specific implementations and scope of application in accordance with the teachings of the disclosure. In conclusion, the content of this specification shall not be construed as a limitation to the disclosure.

What is claimed is:

1. A cyberbullying detection method, comprising:
obtaining a to-be-detected data set, wherein the to-be-detected data set comprises multiple sentence texts of multiple users;
classifying the to-be-detected data set by using a classification model based on a bidirectional recurrent neural network, to obtain a probability that each sentence text belongs to cyberbullying;
obtaining a sentence text whose probability of belonging to cyberbullying is greater than a specified probability, to obtain a first sentence text set;
obtaining an attention value of each sentence text in the first sentence text set and an attention value of each user; and
detecting, according to the attention value of each sentence text in the first sentence text set and the attention value of each user, whether each sentence text belongs to cyberbullying.

2. The cyberbullying detection method according to claim 1, wherein before the classifying the to-be-detected data set by using a classification model based on a bidirectional recurrent neural network, to obtain a probability that each sentence text belongs to cyberbullying, the method further comprises:
cleaning each sentence text in the to-be-detected data set to remove a non-alphabetic character, to obtain a preprocessed text sequence.

3. The cyberbullying detection method according to claim 1, wherein the classifying the to-be-detected data set by using a classification model based on a bidirectional recurrent neural network, to obtain a probability that each sentence text belongs to cyberbullying specifically comprises:
inputting the to-be-detected data set into an embedding layer of the classification model, conducting word segmentation processing on each sentence text, and converting each word into a word vector to obtain a vector matrix corresponding to each sentence text;
inputting the vector matrix corresponding to each sentence text into a bidirectional recurrent neural network layer of the classification model, to obtain an output vector, at a hidden layer of the bidirectional recurrent neural network layer, of each word vector corresponding to the sentence text;
inputting the output vector of each word vector at the hidden layer of the bidirectional recurrent neural network layer into an attention layer of the classification model, to obtain an attention value of each word; and
conducting normalization processing according to the attention value of each word, to obtain the probability that each sentence text belongs to cyberbullying.

4. The cyberbullying detection method according to claim 3, wherein the inputting the output vector of each word vector at the hidden layer of the bidirectional recurrent neural network layer into an attention layer of the classification model, to obtain an attention value of each word specifically comprises:
calculating the attention value of each word by using a formula
$${a}_{in} = \frac{{e}^{{u}_{in}^{T} {u}_{w}}}{{Σ}_{n} {e}^{{u}_{ik}^{T} {u}_{w}}} ,$$
wherein u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

5. The cyberbullying detection method according to claim 1, wherein the obtaining an attention value of each sentence text in the first sentence text set and an attention value of each user specifically comprises:
averaging attention values of all words in the sentence text to obtain the attention value of the sentence text, wherein an attention value of each word is obtained in the process of classifying the to-be-detected data set by using the classification model based on the bidirectional recurrent neural network; and
averaging attention values of all sentence texts corresponding to the user to obtain the attention value of the user.

6. The cyberbullying detection method according to claim 1, wherein after the detecting, according to the attention value of each sentence text in the first sentence text set and the attention value of each user, whether each sentence text belongs to cyberbullying, the method further comprises:
obtaining all sentence texts that belong to cyberbullying, to obtain a second sentence text set; and
determining a bullying degree of each sentence text in the second sentence text set by using a formula
$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$
wherein severity is a value of the bullying degree of the sentence text, bₐₜₜ represents an attention value of the sentence text, p_{b} represents the number of all sentence texts written by a user corresponding to the sentence text, asst_{i,att} represents an attention value of a sentence text of an i^{th} assistant of the user, and pₐₛₛₜ_{ᵢ} represents the number of all sentence texts written by the i^{th} assistant of the user.

7. A cyberbullying detection system, comprising:
a to-be-detected data set obtaining module, configured to obtain a to-be-detected data set, wherein the to-be-detected data set comprises multiple sentence texts of multiple users;
a classification module, configured to classify the to-be-detected data set by using a classification model based on a bidirectional recurrent neural network, to obtain a probability that each sentence text belongs to cyberbullying
a first-sentence-text-set obtaining module, configured to obtain a sentence text whose probability of belonging to cyberbullying is greater than a specified probability, to obtain a first sentence text set;
an attention value obtaining module, configured to obtain an attention value of each sentence text in the first sentence text set and an attention value of each user; and
a cyberbullying detection module, configured to detect, according to the attention value of each sentence text in the first sentence text set and the attention value of each user, whether each sentence text belongs to cyberbullying.

8. The cyberbullying detection system according to claim 7, wherein the classification module specifically comprises:
an embedding layer processing unit, configured to input the to-be-detected data set into an embedding layer of the classification model, conduct word segmentation processing on each sentence text, and convert each word into a word vector to obtain a vector matrix corresponding to each sentence text;
a bidirectional recurrent neural network layer processing unit, configured to input the vector matrix corresponding to each sentence text into a bidirectional recurrent neural network layer of the classification model, to obtain an output vector, at a hidden layer of the bidirectional recurrent neural network layer, of each word vector corresponding to the sentence text;
an attention layer processing unit, configured to input the output vector of each word vector at the hidden layer of the bidirectional recurrent neural network layer into an attention layer of the classification model, to obtain an attention value of each word; and
a normalization processing unit, configured to conduct normalization processing according to the attention value of each word, to obtain the probability that each sentence text belongs to cyberbullying.

9. The cyberbullying detection system according to claim 8, wherein the attention layer processing unit calculates the attention value of each word by using a formula
$${a}_{in} = \frac{{e}^{{u}_{in}^{T} {u}_{w}}}{{Σ}_{n} {e}^{{u}_{ik}^{T} {u}_{w}}} ,$$
wherein u_{w} is a randomly initialized text context vector, uᵢₙ is an output vector corresponding to a word vector wᵢₙ, uᵢₖ is an output vector corresponding to a word vector wᵢₖ; and T is a transposition symbol of a vector.

10. The cyberbullying detection system according to claim 7, wherein the system further comprises:
a second-sentence-text-set obtaining module, configured to: after it is detected, according to the attention value of each sentence text in the first sentence text set and the attention value of each user, whether each sentence text belongs to cyberbullying, obtain all sentence texts that belong to cyberbullying, to obtain a second sentence text set; and
a bullying degree determining module, configured to determine a bullying degree of each sentence text in the second sentence text set by using a formula
$$severity = \frac{{b}_{att} \times {p}_{b} + Σ ( {asst}_{i , att} \times {p}_{{asst}_{i}} )}{{p}_{b} + Σ {p}_{{asst}_{i}}} ,$$
wherein severity is a value of the bullying degree of the sentence text, bₐₜₜ represents an attention value of the sentence text, p_{b} represents the number of all sentence texts written by a user corresponding to the sentence text, asst_{i,att} represents an attention value of a sentence text of an i^{th} assistant of the user, and pₐₛₛₜ_{ᵢ} represents the number of all sentence texts written by the i^{th} assistant of the user.
